(19) United States
(12) Patent Application Publication
(10) Pub. No.: US 2015/0327334 A1
(43) Pub. Date: Nov. 12, 2015

(54) HEATING ELEMENT AND METHOD FOR MANUFACTURING SAME

(71) Applicant: LG CHEM, LTD., Yeongdeungpo-gu, Seoul (KR)

(72) Inventors: Hyeon CHOI, Daejeon (KR); Sujin KIM, Daejeon (KR); Ki-Hwan KIM, Daejeon (KR)

(21) Appl. No.: 14/655,600

(22) PCT Filed: Feb. 21, 2014
(86) PCT No.: PCT/KR2014/001432

§ 371 Date: Jun. 25, 2015

(30) Foreign Application Priority Data
Feb. 22, 2013 (KR) 10-2013-0018949

(51) Int. Cl. H05B 3/86; H01C 17/28; H01C 17/00; H05B 1/02; H05B 3/28

(52) U.S. Cl. CPC H05B 3/86; H05B 1/0236; H05B 3/286; H01C 17/00; H01C 17/28; H05B 2203/002

(57) ABSTRACT

Provided are a heating element including: a substrate; a conductive heating unit provided on the substrate; and two busbars provided to apply voltages to both ends of the conductive heating unit, respectively, in which the conductive heating unit includes a conductive heating pattern area and two conductive layer areas provided at both ends of the conductive heating pattern area, and the two busbars are provided on the conductive layer areas, respectively, and a method of preparing the same.

### TECHNICAL FIELD

This application claims priority to and the benefit of Korean Patent Application No. 10-2013-0018949 filed in the Korean Intellectual Property Office on Feb. 22, 2013, the entire contents of which are incorporated herein by reference.

The present application relates to a heating element and a method for preparing the same.

### BACKGROUND ART

Frost is generated on vehicle windows due to a difference in temperature between the outside and the inside of a vehicle in the winter or on a rainy day. Further, in the case of an indoor ski resort, a dew condensation phenomenon occurs due to a difference in temperature between the inside with a slope and the outside of the slope. In order to solve the problem, heating glass has been developed. The heating glass uses a concept that heat is generated from a heating wire by applying electricity to both terminals of the heating wire after attaching a heating wire sheet onto a glass surface or directly forming the heating wire on the glass surface and a temperature of the glass surface is increased by the generated heat.

In order to prepare the heating glass, methods of connecting electrodes to both front ends after forming a front heating layer through a sputtering process by using a transparent conductive material such as indium tin oxide (ITO) thin film or an Ag thin film are proposed. However, there is a problem in that the heating glass prepared by the above methods cannot be driven at a low voltage due to a high surface resistance. Accordingly, when one intends to generate heat at the low voltage, an attempt to use the heating wire such as a metal wire has been proposed.

In the driving method at the low voltage, in order to generate a predetermined amount of heat, an amount of current needs to be increased. For example, in order to generate the heat of 600 W at 12 V, current of 50 A needs to be used. As the current amount is increased, as a kind of busbar which may supply the current to the metal wire, a kind of and a forming method of the busbar must be selected for simultaneously controlling the heat generated in the busbar and the heat generated due to a contact resistance of the busbar and a transparent heating part. Particularly, in the case of using the metal wire, the contact with the busbar is a very important problem due to the small line width and a line height of the metal wire.

### DETAILED DESCRIPTION OF THE INVENTION

### Technical Problem

An object of the present invention is to provide a heating element and a method for preparing the same that may prevent a resistance value between busbars of the heating element from being increased or local heat in a heating pattern from being generated.

### Technical Solution

An exemplary embodiment of the present invention provides a heating element including: a substrate; a conductive heating unit provided on the substrate; and two busbars provided to apply voltages to both ends of the conductive heating unit, respectively, in which the conductive heating unit includes a conductive heating pattern area and two conductive layer areas provided at both ends of the conductive heating pattern area, and the two busbars are provided on the conductive layer areas, respectively.

Further, another exemplary embodiment of the present invention provides a method of preparing a heating element including: forming a conductive heating unit including a conductive heating pattern area and two conductive layer areas provided at both ends of the conductive heating pattern area, on a substrate; and forming busbars on the conductive layer areas, respectively.

Further, yet another exemplary embodiment of the present invention provides a heating element for a vehicle or architecture including the heating element.

Further, still another exemplary embodiment of the present invention provides a display device including the heating element.

### Advantageous Effects

According to the exemplary embodiment of the present invention, it is possible to prevent local heat between the heating element and the busbar from being generated by positioning the busbar on a conductive layer area to control a contact resistance between the heating element and the busbar.

### BRIEF DESCRIPTION OF DRAWINGS

FIG. 1 is a diagram schematically illustrating a heating element according to an exemplary embodiment of the present invention.

FIG. 2 is a diagram schematically illustrating a heating element according to Comparative Example of the present invention.

FIG. 3 is a diagram schematically illustrating a heating phenomenon of the heating element according to the exemplary embodiment of the present invention.

FIG. 4 is a diagram schematically illustrating a heating phenomenon of the heating element according to Comparative Example of the present invention.

### DESCRIPTION OF REFERENCE NUMERALS AND SIGN

10: Conductive heating pattern area
20: Conductive layer area
30: Busbar

### BEST MODE

Hereinafter, exemplary embodiments of the present invention will be described in detail.

In a heating element in the related art, a heating pattern is formed by a method of etching a portion except for a pattern after coating a metal thin film of 1 μm or more on a polymer film and forming the pattern with an etching resist by a photolithography method or a printing method. In this case, when the busbar for connecting the heating pattern and an external power supply is provided on the heating pattern, the contact portion of the heating pattern and the busbar is limited and thus a phenomenon in which a resistance value between the busbars increases may occur, and a phenomenon in which the local heat in the heating pattern is generated may occur.

As a result, the heating element according to the present invention includes a substrate, a conductive heating unit provided on the substrate, and two busbars provided to apply respective voltages to both ends of the conductive heating unit, in which the conductive heating unit includes a conductive heating pattern area and two conductive layer areas provided at both ends of the conductive heating pattern area, and the two busbars are provided on the conductive layer areas, respectively.

In the present invention, the two conductive layer areas provided at both ends of the conductive heating pattern area mean non-patterned areas or areas in which the density of the heating pattern is ten times larger than that of the conductive heating pattern area. An aperture ratio of the conductive heating pattern area is 90% or more, and preferably 94% or more, and an aperture ratio of the conductive layer area is 60% or less and preferably 0%. In the present invention, the aperture ratio represents a ratio of the area without the conductive heating wire on the substrate.

In the present invention, an adhesive layer may be provided between the conductive layer area and the busbar. The adhesive layer may include one or more of an acrylate-based material, a urethane-based material, a silicone-based material, and the like, but is not limited thereto. Further, the adhesive layer may be formed by a method of coating an existing adhesive using inkjet, and may use an anisotropic conductive film (ACF) including an existing conductive ball.

Further, in order to improve electric contact between the busbar and the conductive layer area by the adhesive layer, the adhesive layer may further include a conductive material. A detailed example of the conductive material may include metal particles such as copper and silver, a conductive polymer, a combination thereof, and the like, but is not limited thereto. A thickness of the adhesive layer may be more than 0 and 100 μm or less.

In this application, a thickness of the conductive heating pattern area and the conductive layer areas may be 0.1 μm to 20 μm, and 0.2 μm to 5 μm, but is not limited thereto.

Further, the thickness of the busbar may be 1 μm to 100 μm and 10 μm to 60 μm, but is not limited thereto. In the case where the thickness of the busbar is less than 1 μm, as the amount of current increases, the heat generated by the busbar itself may be increased. In the case where the thickness of the busbar is more than 100 μm, costs of electrode materials may be increased and the deterioration of adhesion performance may occur when providing the adhesive layer.

In the present invention, in the case where the conductive heating unit is electrically connected to the busbar and the voltage is applied to the busbar, the conductive heating unit is a means which may generate heat by self-resistance and thermal conductivity. The conductive material having a linear shape may be used as the heating means. In the case where the heating means has a linear shape, the heating means may be made of a transparent or opaque conductive material. In the present invention, in the case where the heating means has the linear shape, even when the material is an opaque material such as metal, the heating means may be configured so as not to obstruct the view by controlling uniformity of a line width and of the pattern as described below.

In this specification, for convenience, in the case where the heating means has the linear shape, the heating means is referred to as a conductive heating wire.

In the present invention, the conductive heating wire may be a straight line, but may be variously modified like a curved line, a wavy line, a zigzag line.

The conductive heating wire may be provided as a pattern such as a stripe, a rhombus, a square grid, a circle, a wave pattern, a grid, and a 2-dimensional grid, and is not limited to a predetermined shape, but may be designed so as not to hinder an optical property by diffraction and interference of light emitted from a predetermined light source. That is, in order to minimize regularity of the pattern, a pattern in which spacing and thicknesses of lines of wave, sine wave, and grid structures are regularly configured may be used. If necessary, a shape of the conductive heating wire pattern may be a combination of two or more patterns.

The pattern of the conductive heating wire may include an irregular pattern.

The irregular pattern may include a pattern in which a ratio (distance distribution ratio) of a standard deviation for an average value of distances between the straight line and adjacent cross points of the conductive heating wire is 2% or more, when the straight line crossing the conductive heating wire is drawn.

The straight line crossing the conductive heating wire may be a line having the smallest standard deviation of the distances between the straight line and adjacent cross points of the conductive heating wire. Further, the straight line crossing the conductive heating wire may be a line extended in a vertical direction with respect to a tangent of any one point of the conductive heating wire. By using such a conductive heating wire pattern, it is possible to prevent a side effect due to diffraction and interference of the light source.

In the straight line crossing the conductive heating wire, 80 or more cross points with the conductive heating wire may be included.

The ratio (distance distribution ratio) of a standard deviation for an average value of the distances between the straight line crossing the conductive heating wire and adjacent cross points of the conductive heating wire may be 2% or more, 10% or more, and 20% or more.

A conductive heating wire pattern having a different shape may be provided on at least a part of the surface of the substrate with the heating wire pattern.

According to another exemplary embodiment of the present invention, the irregular pattern is configured by closed figures of which distribution is continuous, and may include a pattern of which a ratio (area distribution ratio) of a standard deviation for an average value of areas of the closed figures is 2% or more. By using such a conductive heating wire pattern, it is possible to prevent a side effect due to diffraction and interference of the light source.

The number of closed figures may be at least 100.

The ratio (area distribution ratio) of the standard deviation for the average value of the areas of the closed figures may be 2% or more, 10% or more, and 20% or more.

The conductive heating wire pattern having the different shape may be provided on at least a part of the surface of a transparent substrate with the heating wire pattern in which the ratio (area distribution ratio) of the standard deviation for the average value of the areas of the closed figures is 2% or more.

In the case where the patterns are completely irregular, a difference between a rare place and a dense place in the distribution of the lines may occur. There is a problem in that the distribution of the lines may be visible however thin the line width may be. In order to solve a problem of visibility, in the present invention, when the heating wire is formed, regularity and irregularity may be properly harmonized. For example, a basic unit is defined so that the heating wire is not visible or the local heat is not generated, and the heating wire may be formed with an irregular pattern within the basic unit. The distribution of the lines is not concentrated at any one place by using the method to compensate for visibility.

According to another exemplary embodiment of the present invention, the irregular pattern may include a conductive heating wire pattern having a boundary form of figures configuring a Voronoi diagram.

It is possible to prevent the moiré and minimize side effects due to the diffraction and interference of light by forming the conductive heating wire pattern in the boundary form of the figures configuring the Voronoi diagram. The Voronoi diagram is a pattern formed by a method of filling a region having the closest distance between each dot and the corresponding dot as compared with the distance from other dots, when dots called Voronoi diagram generators are disposed in a region to be filled. For example, when large-scale discount stores over the country are represented by dots and customers find the closest large-scale discount store, a pattern representing a commercial zone of each discount store may be exemplified. That is, when a space is filled by regular hexagons and dots of the regular hexagons are selected as the Voronoi diagram generators, a honeycomb structure may be the conductive heating wire pattern. In the present invention, when the conductive heating wire pattern is formed by using the Voronoi diagram generators, there is an advantage of easily determining a complicated pattern shape to minimize the side effects due to the diffraction and interference of light.

In the present invention, the Voronoi diagram generators are regularly or irregularly positioned to use a pattern derived from the generators.

Even in the case where the conductive heating wire pattern is formed in a boundary form of the figures that configure the Voronoi diagram, as described above, in order to solve the visual recognition problem, when the Voronoi diagram generator is generated, the regularity and irregularity may be appropriately harmonized. For example, after the area having a predetermined size is set as a basic unit in the area in which the pattern is provided, the dots are generated so that the distribution of dots in the basic unit has the irregularity, thereby manufacturing the Voronoi pattern. If the above method is used, the visibility may be compensated by preventing the distribution of lines from being concentrated at any one point.

As described above, in order to consider the visibility of the heating wire or adjust heating density required in the display device, the number of the Voronoi diagram generators per unit area may be controlled. In this case, when the number of the Voronoi diagram generators per unit area is controlled, the unit area may be 5 cm2 or less and 1 cm2 or less. The number of the Voronoi diagram generators per unit area may be selected in the range of 25 to 2,500/cm2 and in the range of 100 to 2,000/cm2.

At least one of the figures configuring the pattern in the unit area may have a shape different from the rest of the figures.

According to yet another exemplary embodiment of the present invention, the irregular pattern may include a conductive heating wire pattern of a boundary form of figures formed by at least one triangle configuring a Delaunay pattern.

In detail, the shape of the conductive heating wire pattern is a boundary form of the triangles configuring the Delaunay pattern, a boundary form of figures formed by at least two triangles configuring the Delaunay pattern, or a combination form thereof.

It is possible to minimize the moiré phenomenon and the side effects due to the diffraction and interference of light by forming the conductive heating wire pattern in the boundary form of figures formed by at least one triangle configuring the Delaunay pattern. The Delaunay pattern refers to a pattern formed by drawing triangles so that other dots do not exist in the circumcircle when dots called Delaunay pattern generators are disposed in a region to be filled with patterns and three neighboring dots are connected with each other to draw a triangle and draw a circumcircle including all the apexes of the triangle. In order to form the pattern, Delaunay triangulation and circulation may be repeated based on the Delaunay pattern generators. The Delaunay triangulation may be performed so that a slim triangle is avoided by maximizing minimum angles of all angles of the triangle. The concept of the Delaunay pattern was proposed by Boris Delaunay in 1934.

The pattern of the boundary form of figures formed by at least one triangle configuring the Delaunay pattern may use a pattern derived from the generators by regularly or irregularly positioning the Delaunay pattern generators. In the present invention, when the conductive heating wire pattern is formed by using the Delaunay pattern generators, there is an advantage of easily determining a complicated pattern shape.

Even in the case where the conductive heating wire pattern is formed in the boundary form of figures formed by at least one triangle configuring the Delaunay pattern, in order to solve the visual recognition problem as described above, when the Delaunay pattern generators are generated, the regularity and irregularity may be appropriately harmonized.

In order to consider the visibility of the heating wire or adjust the heating density required in the display device, the number of the Delaunay pattern generators per unit area may be controlled. In this case, when the number of the Delaunay pattern generators per unit area is controlled, the unit area may be 5 cm2 or less and 1 cm2 or less. The number of the Delaunay pattern generators per unit area may be selected in the range of 25 to 2,500/cm2 and in the range of 100 to 2,000/cm2.

At least one of the figures configuring the pattern in the unit area may have a shape different from the rest of the figures.

For the uniform heating and the visibility of the heating element, an aperture ratio of the conductive heating wire pattern may be constant per unit area. The heating element may have a transmittance deviation of 5% or less to any circle having a diameter of 20 cm. In this case, it is possible to prevent the heating element from being locally heated. Further, in the heating element, the standard deviation of the surface temperature of the substrate after heating may be within 20%. However, for a specific purpose, the conductive heating wire may also be disposed so that the temperature deviation occurs in the heating element.

In order to maximize an effect of minimizing the side effects due to diffraction and interference of the light, the conductive heating wire pattern may be formed so that an area of the pattern formed by asymmetrical figures is 10% or more of the entire pattern area. Further, the conductive heating wire pattern may be formed so that an area of the figures, in which at least one of lines connecting a central point of any one figure configuring the Voronoi diagram and central points of the adjacent figures forming a boundary with the figure has a length different from the rest of the lines, is 10% or more of the entire area of the conductive heating wire pattern. Further, the conductive heating wire pattern may be formed so that an area of the pattern formed by the figures, in which at least one side of the figure formed by at least one triangle configuring the Delaunay pattern has a length different from the rest of the sides, is 10% or more of the entire area with the conductive heating wire pattern.

When the heating wire pattern is prepared, a large-area pattern may also be prepared by using a method of using a method of connecting a limited area repetitively after designing the pattern in the limited area. In order to repetitively connect the patterns, the repetitive patterns may be connected with each other by fixing the positions of the dots of each side. In this case, the limited area may have an area of 1 cm2 or more and 10 cm2 or more in order to minimize the moiré phenomenon and the diffraction and interference of light due to the repetition.

In the present invention, first, after determining a desired pattern shape, the conductive heating wire pattern having a thin line width and precision may be formed on the substrate by using a printing method, a photolithography method, a photography method, a method using a mask, a sputtering method, an inkjet method, or the like. The pattern shape may be determined by using the Voronoi diagram generators or the Delaunay pattern generators and as a result, the complicated pattern shape may be easily determined. Herein, the Voronoi diagram generators and the Delaunay pattern generators refer to dots disposed so as to form the Voronoi diagram and the Delaunay pattern as described above, respectively. However, the scope of the present invention is not limited thereto and the desired pattern shape may also be determined by using other methods.

The printing method may be performed by transferring and then firing a paste including a conductive heating wire material on the substrate in a desired pattern shape. The transfer method is not particularly limited, but the desired pattern may be transferred on the substrate by forming the pattern shape on a pattern transfer medium such as an intaglio or a screen and using the formed pattern shape. The method of forming the pattern shape on the pattern transfer medium may use methods which are known in the art.

The printing method is not particularly limited, and may use a printing method such as an offset printing method, a screen printing method, a gravure printing method, or the like. The offset printing method may be performed by primarily transferring a paste with a silicon rubber called a blanket after filling the paste in the intaglio with the engraved pattern and then secondarily transferring the paste by contacting the blanket and the substrate. The screen printing method may be performed by directly positioning the paste on the substrate through a hollow screen while pressing a squeegee after positioning the paste on the screen having the pattern. The gravure printing method may be performed by rolling a blanket engraved with a pattern on a roll and filling a paste in the pattern to be transferred to the substrate. In the present invention, the methods may be used in combination, in addition to the methods. Further, other printing methods which are known to those skilled in the art may also be used.

In the case of the offset printing method, since almost the whole paste is transferred to the substrate such as glass due to a releasing property of the blanket, a separate blanket cleaning process is not required. The intaglio may be fabricated by precisely etching the glass on where a desired conductive heating wire pattern is engraved and also, for durability, a metal or diamond-like carbon (DLC) may be coated on the glass surface. The intaglio may also be fabricated by etching a metal plate.

In the present invention, in order to more precisely implement a conductive heating wire pattern, the offset printing method may be used. The offset printing method may be performed by filling the paste in the pattern of the intaglio by using a doctor blade and then performing a primary transfer by rotating the blanket at a first step and performing a secondary transfer on the surface of the substrate by rotating the blanket at a second step.

The present invention is not limited to the above printing methods and may also use a photolithography process. For example, the photolithography process may be performed by forming a conductive heating wire pattern material layer on the entire surface of the substrate, forming a photoresist layer thereon, patterning the photoresist layer by a selective exposing and developing process, etching the conductive heating wire pattern material layer by using the patterned photoresist layer as a mask to pattern the conductive heating wire, and then, removing the photoresist layer.

Particularly, a conductive heating pattern area is formed by etching the conductive heating pattern material layer, and a conductive layer area which is a non-etching area may be formed at both ends of the conductive heating pattern area. In this case, the busbar may be formed on the conductive layer area which is the non-etching area.

In the related art, the busbar is formed on the conductive heating pattern area, and the contact portion of the conductive heating pattern and the busbar is limited, and as a result, a phenomenon in which the resistance value between the busbars is increased may occur, and a phenomenon in which local heat in the conductive heating pattern is generated may occur. However, in this application, by positioning the busbar on the conductive layer area which a pattern density is ten times larger than that of the conductive heating pattern area, it is possible to prevent the resistance value between the busbars of the heating element from being increased or the local heat in the heating pattern from being generated.

The conductive heating wire pattern material layer may also be formed by laminating a metal thin film such as copper, aluminum, and silver on the transparent substrate by using an adhesive layer. Further, the conductive heating wire pattern material layer may also be a metal layer formed on the transparent substrate by using a sputtering or physical vapor deposition method. In this case, the conductive heating wire pattern material layer may also be formed as a multilayered structure of a metal having good electrical conductivity such as copper, aluminum, silver, and platinum and a metal having good attachment with the substrate and dark colors such as Mo, Ni, Cr, and Ti. In this case, the thickness of the metal thin film may be 20 μm or less and 5 μm or less.

In the present invention, the photoresist layer may also be formed by using a printing process instead of the photolithography process in the photolithography process.

Further, the present invention may also use the photography method. For example, after a photosensitive material including silver halide is coated on the substrate, the pattern may also be formed by selectively exposing and developing the photosensitive material. A more detailed example is as follows. First, a negative photosensitive material is coated on a substrate on which a pattern is to be formed. In this case, as the substrate, a polymer film such as PET and acetyl celluloid may be used. Here, a polymer film material member coated with the photosensitive material is called a film. The negative photosensitive material may be generally constituted by silver halide obtained by mixing a small amount of AgI with AgBr which is very sensitive to and regularly reacts to light. Since an image obtained by photographing and developing a general negative photosensitive material is a negative image having an opposite contrast to a subject, the photographing may be performed by using a mask having a pattern shape to be formed, preferably, an irregular pattern shape.

In order to increase conductivity of the heating wire pattern formed by using the photolithography and photography processes, a plating process may further be performed. The plating may be performed by using an electroless plating method, a plating material may use copper or nickel, and after copper plating is performed, nickel plating may be performed thereon, but the scope of the present invention is not limited to these examples.

Further, the present invention may also use the method using a mask. For example, after a mask having a heating wire pattern shape is positioned near the substrate, the pattern may be formed by using a method of depositing the heating wire pattern material on the substrate. In this case, the deposition method may use a heat deposition method by heat or electron beam, a physical vapor deposition (PVD) method such as sputtering, and a chemical vapor deposition (CVD) method using an organometal material.

In the present invention, the substrate is not particularly limited, but light transmittance may be 50% or more, and 75% or more. In detail, the substrate may use glass, and use a plastic substrate or a plastic film. In the case of using the plastic film, after forming the conductive heating wire pattern, the glass may be attached to at least one surface of the substrate. In this case, the glass or the plastic substrate may be attached to the surface with the conductive heating wire pattern of the substrate. The plastic substrate or film may use materials known in the art, and for example, may be a film having the visible-light transmittance of 80% or more, such as polyethylene terephthalate (PET), polyvinylbutyral (PVB), polyethylene naphthalate (PEN), polyethersulfone (PES), polycarbonate (PC), and acetyl celluloid. A thickness of the plastic film may be 12.5 to 500 μm and 50 to 250 μm. In the present invention, the conductive heating wire material may use metals having excellent thermal conductivity. Further, a specific resistance of the conductive heating wire material may be 1 microOhm cm or more to 200 microOhm cm or less. As a detailed example of the conductive heating wire material, copper, silver, platinum, molybdenum, nickel, chromium, titanium, alloys thereof, carbon nanotube (CNT), and the like may be used, and silver is most preferred. The conductive heating wire material may be used in a particle form. In the present invention, as the conductive heating wire material, copper particles coated with silver may also be used.

In the present invention, when the conductive heating wire is prepared by using a printing process using a paste, the paste may further include an organic binder in addition to the aforementioned conductive heating wire material in order to facilitate the printing process. The organic binder may have volatility during a firing process. The organic binder may include a polyacrylic resin, a polyurethane resin, a polyester resin, a polyolefin resin, a polycarbonate resin, a cellulose resin, a polyimide resin, a polyethylene naphthalate resin, a modified epoxy, and the like, but is not just limited thereto.

In order to improve adhesion of the paste to the transparent substrate such as glass, the paste may further include a glass frit. The glass frit may be selected from a commercial product, but may use an eco-friendly glass frit without a lead component. In this case, a size of the used glass frit may have an average aperture of 2 μm or less, and may have a maximum aperture of 50 μm or less.

If necessary, a solvent may be further added to the paste. The solvent includes butyl carbitol acetate, carbitol acetate, cyclohexanon, cellosolve acetate, terpineol, and the like, but the scope of the present invention is not limited to the examples.

In the present invention, when the paste including the conductive heating wire material, the organic binder, the glass frit, and the solvent is used, weight ratios of respective components may be 50 to 90 wt % of the conductive heating wire material, 1 to 20 wt % of the organic binder, 0.1 to 10 wt % of the glass frit, and 1 to 20 wt % of the solvent.

In the present invention, in the case of using the aforementioned paste, a heating wire having conductivity during a firing process after printing the paste is formed. In this case, a firing temperature is not particularly limited, but may be 500 to 800° C. and 600 to 700° C. When the substrate forming the heating wire pattern is glass, if necessary, the glass may be molded so as to be suitable for a desired use for architecture or vehicles during the firing process. For example, when glass for the vehicle is molded to be curved, the paste may also be fired. Further, in the case where the plastic substrate or film is used as the substrate on which the conductive heating wire pattern is formed, the firing may be performed at a relatively low temperature. For example, the firing may be performed at 50 to 350° C.

A line width of the conductive heating wire may be 100 μm or less and 30 μm or less, 25 μm or less and 10 μm or less, and more preferably 7 μm or less and 5 μm or less. The line width of the conductive heating wire may be 0.1 μm or more and 0.2 μm or more. A distance between the lines of the conductive heating wire may be 30 mm or less, 0.1 μm to 1 mm, 0.2 μm to 600 μm or less, and 250 μm or less.

A line height of the heating wire may be 20 μm or less, 5 μm or less, and 2 μm or less. In the present invention, the line width and the line height of the heating wire may be uniform by the aforementioned methods.

In the present invention, uniformity of the heating wire may be within the range of ±3 μm in the case of the line width and within the range of ±1 μm in the case of the line height.

In the present invention, a conductive heating surface may be made of a transparent conductive material. Examples of the transparent conductive material may include ITO and ZnO-based transparent conductive oxides. The transparent conductive oxides may be formed by a sputtering method, a sol-gel method, and a vapor deposition method, and may have a thickness of 10 to 1,000 nm. Further, the conductive heating surface may also be formed by coating an opaque conductive material with a thickness of 1 to 100 nm. As the opaque conductive material, Ag, Au, Cu, Al, and carbon nanotube may be included.

The heating element according to the present invention may further include a power supply unit connected to the busbar. The busbar may also be formed simultaneously with the formation of the conductive heating unit, or may also be formed by using the same or a different printing method after forming the conductive heating unit. For example, after the conductive heating wire is formed by using an offset printing method, the busbar is formed through the screen printing. In this case, a thickness of the busbar may be 1 to 100 μm and 10 to 50 μm. The connection between the busbar and the power supply unit may be performed through soldering and physical contact with a structure having good conductive heating.

The busbar may be made of the same material as a material configuring the aforementioned conductive heating unit. In more detail, the busbar may include a metal selected from a group consisting of copper, aluminum, silver, platinum, molybdenum, nickel, chromium, and titanium, or alloys thereof, but is not limited thereto.

Further, the busbar may be formed by using a conductive tape including a metal selected from a group consisting of copper, aluminum, silver, platinum, molybdenum, nickel, chromium, and titanium, or alloys thereof.

In the related art, in the case of using the conductive tape as the busbar, the electric contact on the conductive heating pattern and the conductive tape is hindered due to an adhesive component which exists on the conductive tape. Particularly, in the case where the pattern density of the conductive heating pattern area is low, since electric insulation due to the adhesive component is increased, the contact resistance cannot help to being increased. Due to the contact resistance, the local heat is generated between the conductive tape and the conductive heating pattern when the voltage is applied, and as a result, substantially, it is difficult to use the conductive tape as the busbar. However, in the present invention, by forming the busbar on the conductive layer area provided at both ends of the conductive heating pattern area, the contact portion between the conductive tape and the conductive layer area is increased to minimize the contact resistance generated in the related art, and as a result, the conductive tape may be used as the busbar.

In this application, the heating element may further include one or two power supply unit connecting areas connected to each of the busbars. In the related art, a plurality of areas that connect the busbar and the power supply unit for uniform heating of the heating element is formed in the busbar, but the heating element according to the present application includes busbars on two conductive layer areas provided at both ends of the conductive heating pattern, and as a result, in the case of forming one or two power supply unit connecting areas, the uniform heating of the heating element may be achieved.

In order to cover the busbar, a black pattern may be formed. The black pattern may be printed by using a paste containing cobalt oxide. In this case, as the printing method, the screen printing may be used, and the thickness may be 10 to 100 μm. The conductive heating unit and the busbar may also be formed before or after forming the black pattern.

The heating element according to the present invention may further include a transparent substrate provided on the surface of the substrate with the conductive heating unit and the busbar. As described above, the additional transparent substrate may use glass, a plastic substrate, or film. An adhesive film may be interposed between the conductive heating means and the additional transparent substrate during the attachment of the additional transparent substrate. A temperature and a pressure may be controlled during the adhering process.

As a material of the adhesive film, any material having adhesion and becoming transparent after adhering may be used. For example, the material may use a PVB film, an EVA film, a PU film, or the like, but is not limited only to those examples. The adhesive film is not particularly limited, but the thickness thereof may be 100 to 800 μm.

In one particular exemplary embodiment, primary adhering is performed by inserting the adhesive film between the transparent substrate with the conductive heating means and the additional transparent substrate and removing air by increasing a temperature by inserting and depressurizing the adhesive film in a vacuum bag or increasing a temperature using a hot roll. In this case, pressure, a temperature, and a time vary according to a kind of adhesive film, but generally, a temperature may be gradually increased from room temperature to 100° C. under a pressure of 300 to 700 torr. In this case, generally, the time may be within 1 hour. A laminated body pre-adhered after finishing the primary adhering is secondarily adhered through an autoclaving process of applying a pressure to increase a temperature in an autoclave. The secondary attachment varies according to a kind of adhesive film, but may be performed at a pressure of 140 bars or more and a temperature of about 130 to 150° C. for 1 hour to 3 hours or about 2 hours and then, slow cooling may be performed.

In another detailed exemplary embodiment, unlike the aforementioned 2-step adhering process, an adhering method in one step may be used by using vacuum laminator equipment. While the temperature is increased up to 80 to 150° C. stepwise and cooled slowly, the adhering may be performed by reducing the pressure (to 5 mbar) up to 100° C. and thereafter, increasing the pressure (to 1,000 mbar).

The heating element according to the present invention may have a curved shape.

In the heating element according to the present invention, when the heating means has a linear shape, an aperture ratio of the conductive heating wire pattern, that is, a ratio of a region which is not covered by the pattern may be 90% or more. The heating element according to the present invention has an excellent heating characteristic capable of increasing the temperature while the aperture ratio is 90% or more and a temperature deviation is maintained at 10% or less within 5 minutes after the heating operation.

The heating element according to the present invention may be connected to the power supply for heating, and in this case, the heating value may be 700 W or less per m2, 300 W or less, and 100 W or more. Since the heating element according to the present invention has excellent heating performance even at low voltage, for example, 30 V or less or 20 V or less, the heating element may be usefully used even in vehicles or the like. The resistance in the heating element may be 5 ohm/square or less, 1 ohm/square or less, and 0.5 ohm/square or less. The heating element according to the present invention may be applied to various transport vehicles such as a car, a ship, a train, a high-speed train, an airplane, and the like, glass used in a house or other buildings, or a display device. Particularly, since the heating element according to the present invention may have the excellent heating characteristic even at low voltage, minimize the side effects due to the diffraction and interference of the light source after sunset, and be invisibly formed with the aforementioned line width as described above, the heating element may also be applied to front windows of transport vehicles such as a car unlike the related art.

Further, a method of preparing the heating element according to the present application includes forming a conductive heating unit including a conductive heating pattern area and two conductive layer areas provided at both ends of the conductive heating pattern area, on a substrate; and forming a busbar on each conductive layer area.

In the method of preparing the heating element according to the present application, since detailed materials of the substrate, the conductive heating pattern area, the conductive layer, the busbar, and the like and forming methods are the same as described above, the detailed description thereof will be omitted.

Further, the heating element according to the present invention may be applied to the display device.

In the case of a 3D TV based on a liquid crystal which has been recently introduced, a 3D image is implemented due to binocular disparity. A method most commonly used in order to generate the binocular disparity is to use glasses having shutters synchronized with a read frequency of a liquid crystal display. In the method, left-eye and right-eye images need to be alternately displayed in the liquid crystal display, and in this case, when a change speed of the liquid crystal is slow, an overlapping phenomenon of the left-eye image and the right-eye image may occur. A viewer experiences an unnatural 3D effect due to the overlapping phenomenon, and as a result, may feel dizzy.

A moving speed of the liquid crystal used in the liquid crystal display may be changed according to an ambient temperature. That is, when the liquid crystal display is driven at a low temperature, a changed speed of the liquid crystal becomes slow and when the liquid crystal display is driven at a high temperature, a changed speed of the liquid crystal becomes fast. Currently, in the case of the 3D TV using the liquid crystal display, heat generated from a backlight unit may influence a liquid crystal speed. Particularly, in the case where the backlight unit of a product known as an LED TV is disposed only at an edge of the display, since the heat generated from a backlight unit increases only a temperature around the backlight unit, a deviation in a liquid crystal driving speed may occur and as a result, non-ideal implementation of the 3D image may be deteriorated.

Accordingly, in the present invention, the aforementioned heating element is applied to the display device, particularly, the liquid crystal display, such that an excellent display characteristic may be shown even at an initial driving at a low temperature, and the display characteristic may be uniformly provided in the entire display screen even in the case where the temperature deviation occurs in the entire display screen according to a position of the light source like the case where the light source such as an edge-type light source is disposed at the side. Particularly, as the heating function is provided to the liquid crystal display, the ambient temperature of the liquid crystal is increased and as a result, a high change speed of the liquid crystal is implemented, thereby minimizing distortion of the 3D image occurring in the 3D display device.

When the heating element according to the present invention is included in the display device, the display device may include a display panel and a heating element provided on at least one side of the display panel. In the case where the display device includes the edge-type light source, the heating unit disposed close to the light source in the heating element has a relatively longer length of the busbar and the heating unit disposed far away from the light source has a relatively shorter length of the busbar, thereby compensating for the temperature deviation according to a light source. As described above, the heating is locally performed in order to compensate for the temperature deviation and the surface resistance of the conductive heating surface or the pattern density of the conductive heating wire becomes uniform in the entire display screen unit of the display device, thereby ensuring visibility.

The heating element may be provided on the additional transparent substrate and may also be provided on one constituent element of the display panel or other constituent elements of the display device.

For example, the display panel may include two substrates and a liquid crystal cell including a liquid crystal material sealed between the substrates, and the heating element may be provided at the inside or the outside of at least one of the substrates. Further, the display panel may include polarizing plates provided at both sides of the liquid crystal cell, respectively, and the heating element may be provided on a phase difference compensation film provided between the liquid crystal cell and at least one of the polarizing plates. In the case where the polarizing plate includes a polarizing film and at least one protective film, the heating element may also be provided on at least one side of the protective film.

Further, the display device may include a backlight unit. The backlight unit may include a direct-type light source or an edge-type light source. In the case where the backlight unit includes the edge-type light source, the backlight unit may further include a light guide plate. The light source may be disposed at one or more edges of the light guide plate. For example, the light source may be disposed at only one side of the light guide plate and may be disposed at two to four edges. The heating element may be provided at the front side or the rear side of the backlight unit. Further, the heating element may also be directly provided at the front side or the rear side of the light guide plate.

In the case where the heating element is provided on the separate transparent substrate, the heating element may be provided on the front side or the rear side of the display panel, provided between the liquid crystal cell and at least one polarizing plate, and provided between the display panel and the light source and at the front or the rear of the light guide plate.

In the case where the heating means of the heating element has a linear shape, the conductive heating wire pattern may include an irregular pattern. It is possible to prevent the moiré phenomenon of the display device by the irregular pattern.

The display device includes the heating element and the configuration of the heating element may be controlled so as to prevent excessive heating and power consumption in electronic products. In detail, the configuration of the heating film included in the display device according to the present invention may be controlled so that power consumption, voltage, and a heating value are in the range to be described below.

When the heating element included in the display device according to the present invention is connected to the power supply, the power of 100 W or less may be consumed. In the case where the power of more than 100 W is consumed, the distortion of the 3D image due to the temperature increase is improved, but power-saving performance of a product may be influenced by an increase in the power consumption. Further, the heating element of the display device according to the present invention may use voltage of 20 V or less and voltage of 12 V or less. When the voltage is more than 20 V, since a risk of an electric shock due to a short circuit occurs, the voltage may be used as low as possible.

A surface temperature of the display device using the heating element according to the present invention is controlled at 40° C. or less. When the temperature is increased to more than 40° C., the distortion of the 3D image may be minimized, but there is a problem in that the power consumption amount may be more than 100 W. When the heating element is connected to the power supply, the heating value may be 400 W or less per m2 and 200 W or less.

The display device using the heating element according to the present invention includes the aforementioned heating element and may include a controller for controlling a surface temperature in order to implement a power-saving product which the electrical products seek in present. As described above, the controller may control the surface temperature of the display device at 40° C. or less. The controller may also have a heating function for only a predetermined time by using a timer and may also have a function of increasing the temperature only up to an optimal temperature and blocking the power supply by attaching a temperature sensor to the surface of the display device. The controller may perform a function for minimizing the power consumption of the display device.

Hereinafter, the present invention will be described in more detail with reference to Examples. However, the following Examples just exemplify the present invention and the scope of the present invention is not limited to the following Examples.

### EXAMPLE

### Example 1

A Cu layer having a thickness of 2 μm was formed on a PET film through a vapor deposition method. After an etching resist material is patterned on the film through a photolithography process, a conductive heating pattern area having a metal pattern having a line width of 5 to 8 μm and a line height of 2 μm was formed through an etching process. In this case, in the formed conductive heating pattern area, an aperture ratio having a width of 56 cm and a length of 81 cm was 95%, and a surface resistance was 0.50 ohm/square. A conductive layer area was formed by forming a non-etching area at upper and lower ends in a longitudinal direction of the heating pattern area. An aperture ratio of the conductive layer area was 0%, and the surface resistance thereof was 0.009 ohm/square.

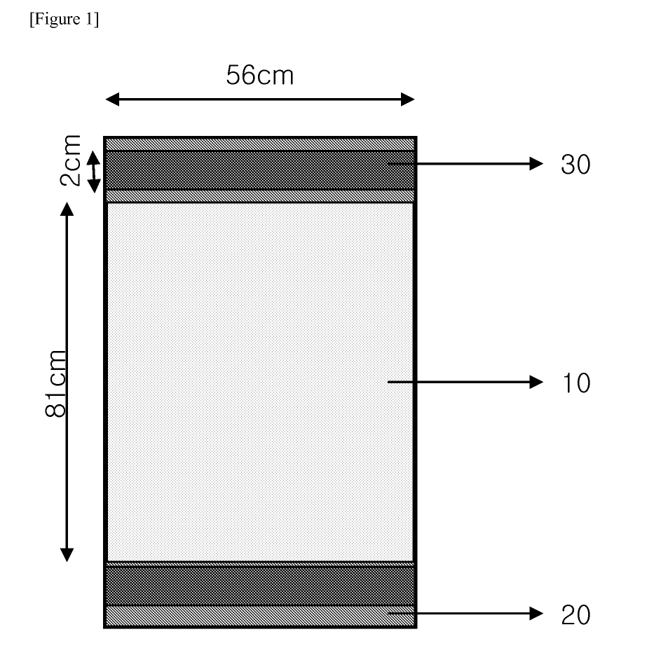

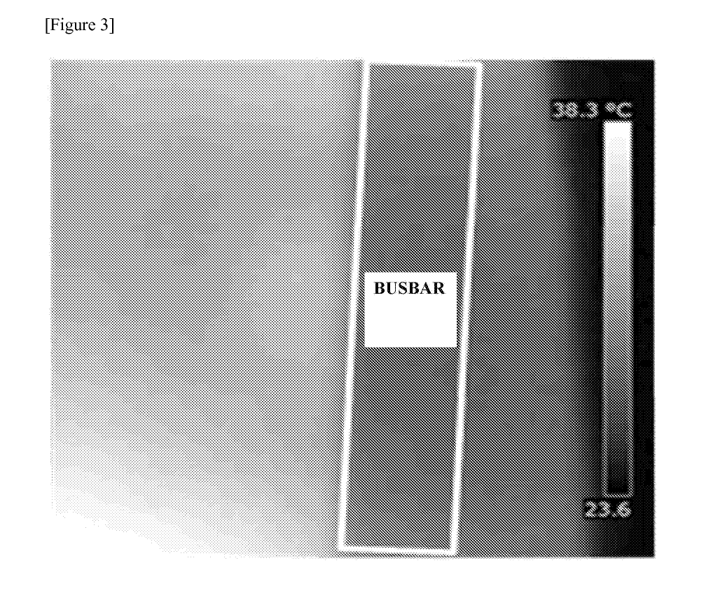

A copper foil having a thickness of 50 μm was attached to the upper and lower conductive layer areas as illustrated in FIG. 1 on the film with a width of 2 cm. When 12 V was applied to both ends, current of 16.7 A flowed, and the resistance was 0.72 ohm. In this case, as a result of measuring the upper end with the copper foil of the heating film by a thermo-graphic camera, as illustrated in FIG. 3, the heat generated in the busbar was slight, and local heat was not generated between the conductive heating pattern area and the conductive layer area.

### Example 2

An experiment was performed by using the same method as Example 1 except that a copper tape with a copper foil of 25 μm and an adhesive of 25 μm instead of the copper foil having a thickness of 50 μm was used on the upper and lower ends. When 12 V was applied to both ends, current of 16.6 A flowed, and the resistance was 0.72 ohm. In this case, as a result of measuring the heating film by a thermo-graphic camera, the heat generated in the busbar was slight, and local heat was not generated between the conductive heating pattern area and the conductive layer area.

### Comparative Example 1

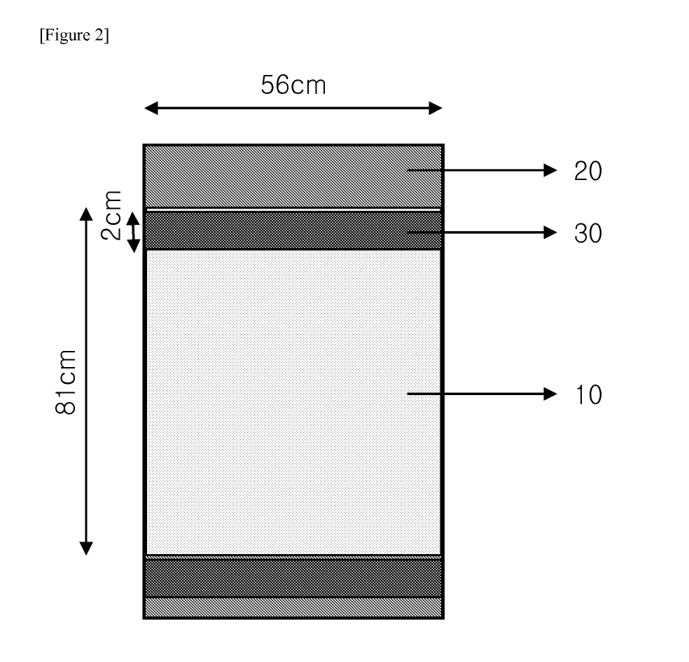

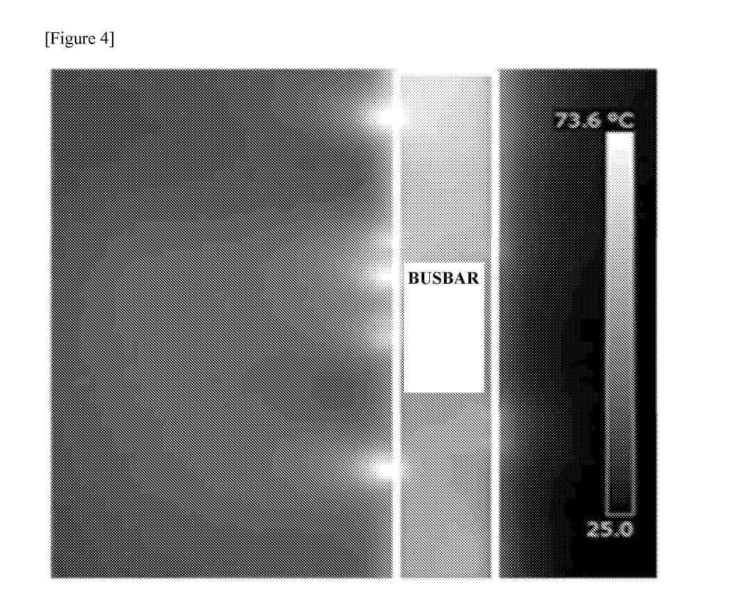

An experiment was performed by using the same method as Example 2, except that the busbar at the upper end was positioned in the conductive heating area as illustrated in FIG. 2. When 12 V was applied to the both ends, current of 15.6 A flowed, and the resistance was 0.77 ohm. In this case, as a result of measuring the heating film by a thermo-graphic camera, as illustrated in FIG. 4, the local heat was generated between the conductive heating pattern area and the conductive layer area.

As described above, in the present invention, it is possible to prevent the local heat between the heating element and the busbar from being generated by positioning the busbar on the conductive layer area to control a contact resistance between the heating element and the busbar.

1. A heating element, comprising: a substrate; a conductive heating unit provided on the substrate; and two busbars provided to apply voltages to both ends of the conductive heating unit, respectively,
wherein the conductive heating unit includes a conductive heating pattern area and two conductive layer areas provided at both ends of the conductive heating pattern area, and
the two busbars are provided on the conductive layer areas, respectively.

2. The heating element of claim 1, wherein an adhesive layer is provided between the conductive layer area and the busbar.

3. The heating element of claim 2, wherein the adhesive layer comprises one or more selected from a group consisting of acrylate-based materials, urethane-based materials, and silicon-based materials.

4. The heating element of claim 3, wherein the adhesive layer comprises one or more selected from a group consisting of metal particles and conductive polymers.

5. The heating element of claim 2, wherein a thickness of the adhesive layer is more than 0 and 100 μm or less.

6. The heating element of claim 1, wherein a thickness of the conductive heating pattern area and the conductive layer area is 0.1 μm to 20 μm.

7. The heating element of claim 1, wherein a thickness of the conductive heating pattern area and the conductive layer area is 0.2 μm to 5 μm.

8. The heating element of claim 1, wherein a thickness of the busbar is 1 μm to 100 μm.

9. The heating element of claim 1, wherein a thickness of the busbar is 10 μm to 60 μm.

10. The heating element of claim 1, wherein an aperture ratio of the conductive heating pattern area is 90% or more, and an aperture ratio of the conductive layer area is 60% or less.

11. The heating element of claim 1, wherein an aperture ratio of the conductive heating pattern area is 94% or more, and an aperture ratio of the conductive layer area is 0%.

12. The heating element of claim 1, wherein the conductive heating pattern area and the conductive layer area comprise a metal selected from a group consisting of copper, aluminum, silver, platinum, molybdenum, nickel, chromium, and titanium; or alloys thereof.

13. The heating element of claim 1, wherein the busbar comprises a metal selected from a group consisting of copper, aluminum, silver, platinum, molybdenum, nickel, chromium, and titanium; or alloys thereof.

14. The heating element of claim 1, wherein the busbar is a conductive tape comprising a metal selected from a group consisting of copper, aluminum, silver, platinum, molybdenum, nickel, chromium, and titanium; or alloys thereof.

15. The heating element of claim 1, further comprising:
a transparent substrate provided on a surface of the substrate with the conductive heating unit and the busbar.

16. The heating element of claim 1, wherein the conductive heating pattern area comprises a conductive heating wire.

17. The heating element of claim 16, wherein the conductive heating wire is a metal wire.

18. The heating element of claim 1, further comprising:
one or two power supply unit connecting areas connected to each of the busbars.

19. A method of preparing a heating element, comprising:
forming a conductive heating unit comprising a conductive heating pattern area and two conductive layer areas provided at both ends of the conductive heating pattern area, on a substrate; and
forming a busbar on each of the conductive layer areas.

20. A heating element for a vehicle or architecture comprising the heating element of claim 1.

21. A display device comprising the heating element of claim 1.
